(19) United States
(12) Patent Application Publication
(10) Pub. No.: US 2014/0087196 A1
(43) Pub. Date: Mar. 27, 2014

(54) FIBRE COMPOSITE COMPONENT AND A PROCESS FOR THE PRODUCTION THEREOF

(71) Applicants: Stefan Lindner, Koln (DE); Klaus Franken, Bergisch-Gladbach (DE); Dirk Passmann, Oberhausen (DE); Peter Nordmann, Dormagen (DE)

(72) Inventors: Stefan Lindner, Koln (DE); Klaus Franken, Bergisch-Gladbach (DE); Dirk Passmann, Oberhausen (DE); Peter Nordmann, Dormagen (DE)

(73) Assignee: Bayer Intellectual Property GmbH, Monheim (DE)

(21) Appl. No.: 14/122,328

(22) PCT Filed: May 25, 2012
(86) PCT No.: PCT/EP2012/059867

§ 371 Date: Nov. 26, 2013

(30) Foreign Application Priority Data
May 30, 2011 (DE) 10 2011 076 723.1

(51) Int. Cl. B29C 45/00; C08L 75/08; C08G 18/32

(52) U.S. Cl. CPC B29C 45/0005; C08G 18/3218; C08L 75/08
USPC 428/423.1; 264/257; 264/571; 528/73; 525/460

(57) ABSTRACT

The present invention relates to fibre composite alloys which can be obtained by impregnation of fibres with a reactive resin mixture of polyisocyanates, dianhydrohexitols, polyols and optionally additives, and also a process for the production thereof.

The present invention relates to fiber composite components which are obtainable via saturation of fibers with a reactive resin mixture of polyisocyanates, dianhydrohexitols, and polyols, and also optionally additives, and also to a process for their production.

U.S. Pat. No. 4,443,563 describes the production of polyurethanes via the reaction of 1,4-3,6 dianhydrohexitol with polyisocyanates and polyols. The resultant polymers can be used for the production of films, coatings, moldings, and foams. The process has the disadvantage that solvents are used for the production of the polymers. It is moreover preferable to produce linear polymers so that these can be melted for the production of products. Because of high viscosity, the resultant polymers are unsuitable for the production of large components.

DE-A 3111093 describes a process for the production of optionally cellular polyurethane plastics with use of diols from the dianhydrohexitol group. The novel chain extenders give high-specification elastomers and foams. The process has the disadvantage that the dianhydrohexitols are either melted, resulting in high temperatures and therefore short casting times, or are used in liquid form as blend with other chain extenders such as 1,4-butanediol, which however causes a rapid viscosity rise. The castability of the mixtures extends only up to 12 minutes. The use of high temperatures is problematic for the vacuum fusion process, since the components, especially in this case the isocyanate, have a high vapor pressure and are therefore withdrawn from the mixture. No production of glassfiber-reinforced plastics is described.

Fiber-reinforced plastics are used as structural material since they have high mechanical strength combined with low weight. The matrix material here is usually composed of unsaturated polyester resins, vinyl ester resins, and epoxy resins.

Fiber composite materials can be used by way of example in aircraft construction, in automobile construction, or in rotor blades of wind turbines.

The known processes for the production of fiber composite components can be utilized, examples being manual lamination, transfer molding, resin injection processes (=Resin Transfer Molding), or vacuum-assisted fusion processes (for example VARTM (Vacuum Assisted Resin Transfer Molding)), or prepreg technology. Particular preference is given to vacuum-assisted infusion processes, since they can produce large components.

However, the processes used hitherto have the disadvantage that hardening of the reactive resin mixture takes a very long time, and this leads to low productivity. In order to increase productivity it is necessary to reduce production cycle time. An important factor here is that the reactive resin mixture has low viscosity over a long period, so that complete saturation of the fibers can be achieved. On the other hand, the curing time should be minimized in order to reduce cycle times. A low hardening temperature is desirable for economic reasons, since it can save energy costs.

It was therefore an object of the present invention to provide a matrix material which permits good saturation and wetting of the fibers and at the same time ensures rapid hardening and good mechanical properties.

Surprisingly, said object was achieved via fiber composite components which are obtainable from fiber layers and from a reactive resin mixture of polyisocyanates, dianhydrohexitols, polyols, and also optionally conventional additives.

The invention provides fiber composite components comprising a fiber layer which has been saturated with polyurethane, where the polyurethane is obtainable from a reaction mixture composed of
A) one or more polyisocyanates
B) one or more polyols with an OH number smaller than 700 mg KOH/g
C) one or more dianhydrohexitols, and
D) optionally additives.

It is preferable that on one of the two sides of the fiber layer comprising polyurethane the composite component of the invention comprises what is known as a spacer material layer, and the composite component of the invention optionally comprises, adjacent to the spacer layer, an additional, second fiber layer comprising polyurethane, where the polyurethane comprised in that layer is preferably the same as the polyurethane comprised in the first-mentioned fiber layer.

Preferred fiber composite components comprise one or more protective and/or decorative layers on the other of the two sides of the first-mentioned fiber layer comprising polyurethane. The protective layers preferably involve one or more gelcoat layers, preferably made of polyurethane (PU) resins, of epoxy resins, of unsaturated polyester resins, or of vinyl ester resins.

A preferred fiber composite component comprises, on that side of the fiber layer comprising polyurethane that is opposite to the gelcoat layer, what is known as a spacer layer, followed by a further fiber layer comprising polyurethane, where the polyurethane comprised therein is preferably the same as the polyurethane comprised in the first-mentioned fiber layer. By way of example, the spacer layer is composed of balsa wood, PVC foam, PET foam, or PU foam. The spacer layer can cover all or part of the area of the fiber layer. Its thickness can also differ across the area.

Particular preference is given to a fiber composite component which comprises, in the fiber layer, a polyurethane which is obtainable from 40-60% by weight, preferably 50-55% by weight, of polyisocyanates (A), 30-50% by weight, preferably 40-48% by weight, of polyols (B), 0.5-10% by weight, preferably 1-5% by weight, of dianhydrohexitols (C) and 0-10% by weight, preferably 1-5% by weight, of additives (D), where the sum of the proportions by weight of the components is 100% by weight. The functionality of the reactive components of the resin mixture (polyisocyanates and polyols) is preferably greater than 2, with resultant formation of a stable, thermoset matrix.

The ratio of the number of NCO groups of component (A) to the number of OH groups of component (B) and (C) is preferably from 0.9:1 to 1.5:1, with preference from 1.04:1 to 1.2:1 and with particular preference from 1.08:1 to 1.15:1.

It is preferable that the dianhydrohexitols (C) are dissolved in advance in the polyol (B), since the mixture can then be mixed at low temperatures with the polyisocyanate (A), with resultant long pot-life times. Even when amounts of dianhydrohexitol (C) are small, the mechanical properties of the resultant matrix and of the fiber composite component improve markedly. The amount of the dianhydrohexitol dissolved in the polyol (B) is preferably 1-20% by weight, with preference 1-15% by weight, with particular preferably 2-12% by weight, and with very particular preference 3-10% by weight.

The proportion of fiber in the fiber composite part is preferably more than 50% by weight, with particular preference more than 65% by weight, based on the total weight of the fiber composite component. In the case of glass fibers, the proportion of fiber can by way of example be determined subsequently by ashing, and the ingoing weight can be monitored.

It is preferable that the fiber composite component, preferably the glassfiber composite component, is transparent.

The invention further provides a process for the production of the fiber composite components of the invention, where
a) a mixture of
   A) one or more polyisocyanates
   B) one or more polyols
   C) one or more dianhydrohexitols, and
   D) optionally additives,
is produced,
b) a fiber material is used as initial charge in a mold half,
c) the mixture produced in a) is introduced into the fiber material from b) to produce a saturated fiber material, and
d) the saturated fiber material hardens at a temperature of from 20 to 120° C., preferably from 70 to 100° C.

It is preferable that the mold half is provided with a release agent before the fiber material is introduced. It is possible to introduce further protective or decorative layers, for example one or more gelcoat layers, into the mold half prior to the introduction of the fiber material.

In one preferred embodiment, what is known as a spacer layer is applied to the fiber material that is already in the mold half, and a further layer of fiber material made of, for example, fiber mats, woven fiber fabric or laid fiber screen, is applied to said spacer layer. The polyurethane mixture is then poured into the layers. The spacer layer is composed by way of example of balsa wood, polyvinyl chloride (PVC) foam, polyethylene terephthalate (PET) foam, or polyurethane (PU) foam.

It is preferable that, after the insertion of the fiber material into the mold half, a foil is placed onto the fiber material, vacuum is generated between the foil and the mold half, and the reaction mixture is introduced via the foil (vacuum assisted resin transfer molding (VARTM)). This process can also produce large components, such as rotor blades of wind turbines. It is also possible, if necessary, to introduce what are known as flow aids (e.g. in the form of mats that are pressure-resistant but resin-permeable) between the foil and the fiber material, and these can in turn be removed after the hardening process.

In the RTM (Resin Transfer Molding) process, which is likewise preferred, the mold is closed by an opposite half, rather than by the vacuum-tight foil, and the resin mixture is charged optionally under pressure into the mold.

The reactive resin mixtures used in the invention have low viscosities and long processing times, and have short hardening times at low hardening temperatures, and thus permit rapid manufacture of fiber composite components.

Another advantage of the reactive resin mixtures used in the invention is improved processing performance. The reactive resin mixtures can be produced and processed at low temperatures. This leads to slow hardening of the components. The components of the reactive resin mixtures can be mixed at from 20 to 50° C., preferably at from 30 to 40° C., and applied to the fiber material. In order to ensure good saturation of the fibers, the reactive resin mixture should preferably have low viscosity during the charging process, and retain low viscosity for as long as possible. This is particularly necessary in the case of large components, since the charging time here is very long (for example up to one hour). It is preferable that the viscosity of the reactive resin mixture of the invention at 35° C. directly after mixing is from 50 to 500 mPas, with preference from 70 to 250 mPas, with particular preference from 70 to 150 mPas. It is preferable that the viscosity of the reactive resin mixture of the invention at a constant temperature of 35° C. one hour after the mixing of the components is smaller than 3300 mPas, particularly smaller than 3000 mPas. The viscosity is determined in accordance with the information in the examples section.

The reactive mixture used in the invention can be processed in casting machines using static mixers or using dynamic mixers, since the mixing time required is only short. This is a major advantage in the production of the fiber composite components of the invention, since for good saturation the reactive resin mixture must have minimal viscosity.

Polyisocyanate component A) used comprises the usual aliphatic, cycloaliphatic, and in particular aromatic di- and/or polyisocyanates. Examples of these suitable polyisocyanates are butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanato-cyclohexyl)methanes and mixtures of these having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologues (pMDI), 1,3- and/or 1,4-bis(2-isocyanatoprop-2-yl)benzene (TMXDI), and 1,3-bis(isocyanatomethyl)-benzene (XDI). It is also possible to use, alongside the abovementioned polyisocyanates, some proportion of modified polyisocyanates having uretdione structure, isocyanurate structure, urethane structure, carbodiimide structure, uretonimine structure, allophanate structure, or biuret structure. Isocyanate used preferably comprises diphenylmethane diisocyanate (MDI) and in particular mixtures of diphenylmethane diisocyanate and polyphenylene polymethylene polyisocyanate (pMDI). The mixtures of diphenylmethane diisocyanate and polyphenylene polymethylene polyisocyanate (pMDI) have a preferred monomer content of from 60 to 100% by weight, preferably from 70 to 95% by weight, particularly preferably from 80 to 90% by weight. The NCO content of the polyisocyanate used should preferably be above 25% by weight, with preference above 30% by weight, with particular preference above 32% by weight. The viscosity of the isocyanate should preferably be ≦150 mPas (at 25° C.), with preference ≦50 mPas (at 25° C.), and with particular preference of ≦30 mPas (at 25° C.).

If a single polyol is added, the OH number thereof gives the OH number of component B). In the case of mixtures, the numeric-average OH number is stated. This value can be determined with reference to DIN 53240-2. The polyol formulation preferably comprises, as polyols, those having a numeric-average OH number of from 200 to 700 mg KOH/g, with preference from 300 to 600 mg KOH/g, and with particular preference from 350 to 500 mg KOH/g. The viscosity of the polyols is preferably ≦800 mPas (at 25° C.). The polyols preferably have at least 60% of secondary OH groups, with preference at least 80% of secondary OH groups, and with particular preference at least 90% of secondary OH groups. Particular preference is given to polyether polyols based on propylene oxide. It is preferable that the average functionality of the polyols used is from 2.0 to 5.0, particularly from 2.5 to 3.5.

The invention can use polyether polyols, polyester polyols, or polycarbonate polyols, preference being given to polyether polyols. Examples of polyether polyols that can be used in the invention are the polytetramethylene glycol polyethers obtainable via polymerization of tetrahydrofuran by means of cationic ring-opening. Equally suitable polyether polyols are adducts of styrene oxide, ethylene oxide, propylene oxide, and/or butylene oxides onto di- or polyfunctional starter molecules. Examples of suitable starter molecules are water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol, and also low-molecular-weight, hydroxylated esters of polyols of this type with carboxylic acids; other examples are hydroxylated oils. The viscosity of the polyols is preferably ≦800 mPas (at 25° C.). The polyols preferably have at least 60% of secondary OH groups, with preference at least 80% of secondary OH groups, and with particular preference to 90% of secondary OH groups. Particular preference is given to polyether polyols based on propylene oxide.

The polyols B) can also comprise fibers, fillers, and polymers.

Dianhydrohexitols C) can be produced via double elimination of water from hexitols, e.g. mannitol, sorbitol, and iditol. Said dianhydrohexitols are known as isomannide, isosorbide, and isoidide, and have the following formula:

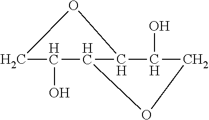

Dianhydrohexitols are particular interest because they can be produced from renewable raw materials. Particular preference is given to isosorbide. Isosorbide is obtainable by way of example as Polysorb® P from Roquette or from Archer Daniels Midland Company.

Additives D) can optionally be added. These involve by way of example catalysts, deaerators, antifoams, fillers, and reinforcing materials. Other known additives and additions can be used if necessary. Particular preference is given to latent catalysts, where these are catalytically active only when temperatures of from 50 to 100° C. are reached.

In one preferred embodiment, polyepoxides are used as additives D). Polyepoxides having particularly good suitability are low-viscosity aliphatic, cycloaliphatic, or aromatic epoxides, and also mixtures of these. The polyepoxides can be produced via reaction of epoxides, such as epichlorohydrin, with alcohols. Alcohols that can be used are by way of example bisphenol A, bisphenol F, bisphenol S, cyclohexane-dimethanol, phenol-formaldehyde resins, cresol-formaldehyde novolaks, butanediol, hexanediol, trimethylolpropane, or polyether polyols. It is also possible to use glycidyl esters, for example of phthalic acid, isophthalic acid, or terephthalic acid, or else mixtures of these. Epoxides can also be produced via epoxidation of organic compounds comprising double bonds, for example via epoxidation of fat oils, such as soy oil, to give epoxidized soy oil. The polyepoxides can also comprise monofunctional epoxides as reactive diluents. These can be produced via the reaction of alcohols with epichlorohydrin, examples being monoglycidyl ethers of C4-C18 alcohols, cresol, and p-tert-butylpenol. Other polyepoxides that can be used are described by way of example in “Handbook of Epoxy resins” by Henry Lee and Kris Neville, McGraw-Hill Book Company, 1967. It is preferable to use glycidyl ethers of bisphenol A which have an epoxide equivalent weight in the range of 170-250 g/eq, particularly with an epoxide equivalent weight in the range from 176 to 196 g/eq. The epoxide equivalent weight can be determined in accordance with ASTM D-1652. By way of example, Eurepox 710 or Araldite® GY-250 can be used for this purpose.

By way of example, it is possible to use from 1 to 20% by weight of polyepoxide as additive D), based on polyol component B), preferably from 2 to 12% by weight, and with particular preference from 4 to 10% by weight.

Fiber material used can comprise sized or unsized fibers, such as glass fibers, carbon fibers, steel fibers or iron fibers, natural fibers, aramid fibers, polyethylene fibers, or basalt fibers. Particular preference is given to glass fibers. The fibers can be used in the form of short fibers of length from 0.4 to 50 mm. Preference is given to continuous-filament-fiber-reinforced composite components via use of continuous fibers. Arrangement of the fibers in the fiber layer can be unidirectional, randomly distributed, or woven. In components with a fiber layer made of a plurality of plies, there is the possibility of ply-to-ply fiber orientation. It is possible here to produce unidirectional fiber layers, cross-bonded layers, or multidirectional fiber layers, where unidirectional or woven plies are laminated to one another. It is particularly preferable to use semifinished fiber products as fiber material, an example being woven fabrics, laid screen, braided fabrics, mats, nonwovens, knitted fabrics, or 3D semifinished fiber products.

The fiber composite components of the invention can be used for the production of rotor blades of wind turbines, for the production of bodywork components of automobiles, or in aircraft construction, in components for constructing buildings or for constructing roads (e.g. manhole covers), and in other structures subject to high loads.

The examples below are intended to provide further explanation of the invention.

### EXAMPLES

In order to determine the properties of the matrix, moldings (sheets) were produced from various polyurethane systems and compared. The polyol mixtures, comprising the components other than the isocyanate, were degassed for 60 minutes at a pressure of 1 mbar and then Desmodur® VP.PU 60RE11 was admixed. This blend was degassed for about 5 minutes at a pressure of 1 mbar and then poured into sheet molds. The sheets were cast at room temperature and conditioned overnight in an oven heated to 80° C. The thickness of the sheet was 4 mm. Transparent sheets were obtained. The quantitative data and properties can be found in the table.

Test specimens for a tensile test in accordance with DIN EN ISO 527 were produced from the sheets, and modulus of elasticity and strength were determined

With the composition from inventive examples 1 to 4 it was possible to produce transparent, glassfiber-reinforced polyurethane materials via the vacuum infusion process with glassfiber content above 60% by weight.

For the production of fiber-reinforced moldings via vacuum infusion, glassfiber rovings (Vetrotex® EC2400 P207) were charged to a Teflon tube of diameter 6 mm in such a way as to give a glassfiber content of about 65% by weight, based on the subsequent component. One end of the Teflon tube was dipped into the reaction mixture, and vacuum was applied to the other end of the tube by using an oil pump in such a way that the reaction mixture was sucked into the tube. Once the materials had been charged to the tubes, they were conditioned at 70° C. for 10 hours. In each case, the Teflon tube was removed, and a transparent molding reinforced with fibers was obtained.

Viscosity was determined 60 minutes after the mixing of the components at a constant temperature of 35° C. by using a rotary viscometer at a shear rate of 60 l/s (a low viscosity for a prolonged period being necessary in the production of relatively large moldings for uniform filling of the mold).

Starting Compounds:

Polyol 1: Glycerol-started polypropylene oxide polyol with functionality 3 and an OH number of 45 mg KOH/g and viscosity 420 mPas (at 25° C.).

Isosorbide: Synonyms: dianhydro-D-glucitol and 1,4:3,6-dianhydro-D-sorbitol; molecular mass 146.14 g/mol; diol with an OH number of 768 mg KOH/g.

Eurepox® 710: Bisphenol A epichlorohydrin resin with average molar mass ≦700 g/mol; epoxide equivalent 183-189 g/eq; viscosity at 25° C.: 10 000-12 000 mPas)

Desmodur® VP.PU 60RE11: Mixture of diphenylmethane 4,4′-diisocyanate (MDI) with isomers and with higher-functionality homologues having 32.6% by weight NCO content; viscosity at 25° C.: 20 mPas.

All quantitative data in the table below are in parts by weight.

TABLE

| | Inventive | Inventive | Inventive | Inventive | Comparative | Comparative |
|---|---|---|---|---|---|---|
| | example 1 | example 2 | example 3 | example 4 | example 5 | example 6 |
| Polyol 1 | 185.25 | 180.5 | 162.0 | 155.45 | 200 | 171 |
| Isosorbide | 4.75 | 9.5 | 18.0 | 17.27 | | |
| Eurepox ® 710 | | | | 17.27 | | |
| 2,3-Butanediol | | | | | | 9 |
| Desmodur ® | 219.74 | 223.55 | 219.01 | 224.12 | 227.9 | 222.63 |
| VP.PU | | | | | | |
| 60RE11 | | | | | | |
| NCO/OH | 110/100 | 110/100 | 110/100 | 110/100 | 110/100 | 110/100 |
| molar ratio | | | | | | |
| Viscosity | 66 | 66 | 68 | 73 | 65 | 70 |
| directly after | | | | | | |
| mixing at | | | | | | |
| 35° C. [mPas] | | | | | | |
| Viscosity 60 min. | 3060 | 2440 | 2490 | 2770 | 3490 | 10 400 |
| after | | | | | | |
| mixing at | | | | | | |
| 35° C. [mPas] | | | | | | |
| Tensile test: | 3200 | 3174 | 3403 | 3391 | 3038 | 3261 |
| Modulus of | | | | | | |
| elasticity | | | | | | |
| [MPa] | | | | | | |
| Tensile test: | 81.2 | 85.2 | 86.3 | 87.2 | 80.3 | 84.4 |
| Strength | | | | | | |
| [MPa] | | | | | | |

Inventive examples 1 to 4, with a short demolding time of 2 hours, reveal a very good combination of a slow viscosity rise at 35° C. to less than 3100 mPas after 60 minutes, which is very important for the production of large fiber-reinforced structural components, together with very good mechanical properties, e.g. strength above 81 MPa and modulus of elasticity above 3100 MPa. Comparative example 5 used no chain extender. Comparative example 6 used 2,3-butanediol as slow-reacting chain extender. Nevertheless, comparative examples 5 and 6 exhibit a markedly faster viscosity rise at 35° C. to a viscosity at 35° C. of well above 3000 mPas after 60 minutes, making it more difficult to produce large fiber-reinforced components. Mechanical properties such as strength and modulus of elasticity are moreover poorer.

1-10. (canceled)

11. A fiber composite component comprising a fiber layer comprising polyurethane, where the polyurethane is obtainable from a reaction mixture composed of
A) one or more polyisocyanates,
B) one or more polyols with an OH number smaller than 700 mg KOH/g,
C) one or more dianhydrohexitols, and
D) optionally additives.

12. The fiber composite component as claimed in claim 11, which further comprises a polyepoxide is used as additive D).

13. The fiber composite component as claimed in claim 11, wherein there is/are one or more gelcoat layers present on one side of the fiber layer comprising polyurethane,

14. The fiber composite component as claimed in claim 13, wherein there is a spacer layer present on that side of the fiber layer comprising polyurethane that is opposite to the gelcoat layer, and said spacer layer is followed by another fiber layer comprising polyurethane.

15. The fiber composite component as claimed in claim 11, where there is a spacer layer present on one side of the fiber layer comprising polyurethane, and said spacer layer is followed by another fiber layer comprising polyurethane.

16. A process for the production of the fiber composite components as claimed in claim 11, which comprises
a) producing a mixture of
A) one or more polyisocyanates
B) one or more polyols with an OH number smaller than 700 mg KOH/g
C) one or more dianhydrohexitols, and
D) optionally additives,
b) a fiber material is used as initial charge in a mold half,
c) introducing the mixture produced in a) into the fiber material from b) to produce a saturated fiber material, and
d) the saturated fiber material hardens at a temperature of from 20 to 120° C.,

17. The process as claimed in claim 16, wherein the temperature is from 70 to 100° C.

18. The process as claimed in claim 16, wherein, prior to the step b),
b′) one or more gelcoat layers are introduced into the mold half.

19. The process as claimed in claim 16, wherein, after the step b) and prior to the step c), a spacer material layer and then a fiber material layer are introduced into the mold half.

20. The process as claimed in claim 18, wherein, after the step b′) and prior to the step c), a spacer material layer and then a fiber material layer are introduced into the mold half,

21. The process as claimed in claim 16, where step c) is carried out by the vacuum infusion process,

22. A process for the production of rotor blades of wind turbines which comprises utilizing the fiber composite components as claimed in claim 11.

23. A process for the production of bodywork components of automobiles which comprises utilizing the fiber composite components as claimed in claim 11.

24. An article which comprises the fiber composite components as claimed in claim 11, wherein the article is used in aircraft construction, in components for constructing buildings or for constructing roads or in other structures subject to high loads.
